(19) United States
(12) Patent Application Publication
(10) Pub. No.: US 2014/0096208 A1
(43) Pub. Date: Apr. 3, 2014

(54) AUTOMATED SYSTEM AND METHOD FOR PROVISIONING AND MANAGING CLOUD DESKTOP SERVICES

(71) Applicant: MRK NETWORKS, INC., Allentown, PA (US)

(72) Inventor: Charles F. Buck, Kempton, PA (US)

(73) Assignee: MRK NETWORKS, INC., Allentown, PA (US)

(21) Appl. No.: 13/950,814

(22) Filed: Jul. 25, 2013

Related U.S. Application Data
(60) Provisional application No. 61/676,063, filed on Jul. 26, 2012.

(51) Int. Cl. G06F 21/31

(52) U.S. Cl. CPC G06F 21/31
USPC 726/5

(57) ABSTRACT

An automated system and method including proprietary software applications and processes to be used by Internet Service Providers, Infrastructure as a service Providers, Independent Software Vendors, Data Center Managers, and Corporate Enterprises to rapidly provision, configure and manage complex information technology environments that exist in virtual space (the cloud) and are provided for end user interaction using the public computer networks (internet) or private computer networks.

### CROSS-REFERENCE TO RELATED APPLICATIONS

This application claims the benefit of United States Provisional Application Ser. No. 61/676,063 entitled “System And Method For Providing Automated Remote Desktop Provisioning And Support” filed Jul. 26, 2012 which is incorporated fully herein by reference.

### TECHNICAL FIELD

The present invention relates to the delivery of computing services by means of the TCPIP Networks and more particularly, relates to a system and method for allowing cloud computing service resellers to provision and maintain customers using an automated process.

### BACKGROUND INFORMATION

Cloud computing refers to the delivery of computing and data storage as a service to a varied community of end user recipients. Cloud computing necessitates that the end-users entrust the cloud service provider with the user's data, software and computational activities over a network. End users access cloud based software applications through a web browser or light-weight desktop or mobile application, while the actual business software and data are stored within the cloud on servers at a remote location. Cloud computing is designed to allow enterprises and even individual users to get their software applications up and running faster, with improved manageability and less maintenance, while enabling the cloud service providers controlling the information technology of the end-user to more rapidly adjust resources to meet fluctuating and sometimes unpredictable user demands.

Although large enterprise users might see immediate cost and deployment savings utilizing the current cloud computing deployment and maintenance technology, one limitation of the current technology is that the time and effort it takes to set up and maintain small business users (those with say only under 100 users) or individual users makes the cloud very expensive and thus not cost effective to this large group of potential users. Additionally for both large enterprises and small business users, the skilled technical employees necessary to maintain a cloud delivery platform are often difficult or impossible to acquire.

Accordingly, a need exists for a system and method which allows a cloud service provider to allow either itself or a reseller of its services to automate the process of establishing and maintaining the cloud platform service for such small businesses and/or individual users.

### SUMMARY OF THE INVENTION

The present invention provides a novel system and method which provides a platform providing increased performance and ease of maintenance to a cloud computing system, while also allowing resellers of applicant's cloud computing services to provide provisioning, support and fulfillment management utilizing trained but nontechnical workers.

The invention includes an automated system for automatically configuring and managing a complex information technology infrastructure comprised of an automated computer system operating under control of a computer program, and including a control panel mechanism, responsive to user input, and configured for allowing a user to establish a cloud services infrastructure including create a new information technology infrastructure client, create end users of the information technology infrastructure, select cloud applications and application licenses to be used by one or more users of the information technology infrastructure and for providing, as control panel output, cloud services infrastructure provisioning information formatted for use by an automated process automation system.

Also included is an operations console mechanism that is responsive to user input, and configured for allowing previously established cloud services infrastructure support and configuration tasks for previously established users of the cloud services infrastructure system including manage existing information technology infrastructure clients, manage users, unlock user accounts, reset user passwords, force users to change their password on the next log in, set up a password that never expires, set up account expiration dates, create distribution and security groups, provide shadow support, log off a user, explore and control processes running on a user's desktop as well as remote installation, and for running reports related to the information technology infrastructure and its users and applications, and for providing, as operations console output, cloud services infrastructure and provisioning information formatted for use by said automated process automation system.

An automated process and system is provided and is coupled to and responsive to the control panel mechanism output and the operations console mechanism output, for automatically, without human intervention and in response to the control panel mechanism output and the operations console mechanism output, for controlling and implementing the process of creating and managing organizational directory structures, data directory structures, users, server systems, application installation, the initial setting of user privileges, and communication of all credentials and access details to the information technology services provider and user organization.

### BRIEF DESCRIPTION OF THE DRAWINGS

These and other features and advantages of the present invention will be better understood by reading the following detailed description, taken together with the drawings wherein:

FIG. 1 is a block diagram of the system according to the present invention;

FIG. 2 is a screen shot of an exemplary cloud control panel portion of the present invention; and

FIG. 3 is a block diagram of the operations console feature of the present invention.

### DETAILED DESCRIPTION OF THE PREFERRED EMBODIMENTS

The present invention features a system and method including proprietary software applications and processes to be used by Internet Service Providers, Infrastructure as a service Providers, Independent Software Vendors, Data Center Managers and Corporate Enterprises, to rapidly configure and manage complex information technology environments that exist in virtual space (the cloud) and are provided for end user interaction using the public computer networks (internet)or private computer networks. The environments consist of users, software applications, data to support and interact with users and software applications, management policies, and the virtual computer systems upon which all of the environment's components exist.

The present invention automates the necessary tools, processes and policies that are required by an information technology specialist to provision (set up a new customer) and subsequently maintain the cloud for any given customer. Specifically, one embodiment of the present invention includes a platform or series of software applications or tools that are installed on a dedicated management platform consisting of one or more servers of the cloud service provider.

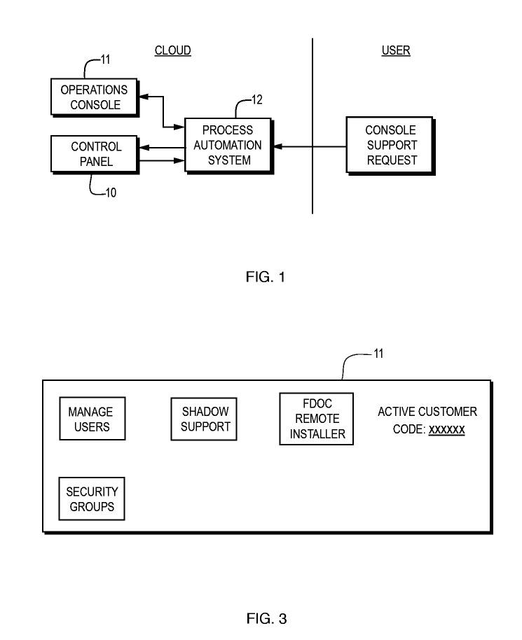

As shown in FIG. 1, this embodiment includes a Control Panel application 10 (or its equivalent functionality as will be explained in greater detail below), an operations console application 11 (or its equivalent functionality which will also be explained in greater detail below) and a process automation system and application 12. All such applications are computer software applications or web pages installed on one or more computer servers of the cloud service provider.

A server is a system (suitable computer hardware operating appropriate and suitable computer software) that responds to requests across a computer network to provide, or help to provide, a network service. Servers can be run on a dedicated computer, which is also often referred to as “the server”, or over one or more networked computers that are capable of hosting servers. Servers generally provide essential services across a network, either to private users inside a large organization or to public users via the Internet. Typical computing servers are database servers, file servers, mail servers, print servers, web servers, gaming servers, application servers, or some other kind of server.

While nearly any personal computer is capable of acting as a network server, a dedicated server will contain features making it more suitable for some environments. These features may include a faster CPU, increased high-performance RAM (memory) and increased storage capacity in the form of a larger or multiple hard drives. Servers also typically have reliability, availability and serviceability (RAS) and fault tolerance features, such as redundancy in power supplies, storage (as in RAID), and network connections.

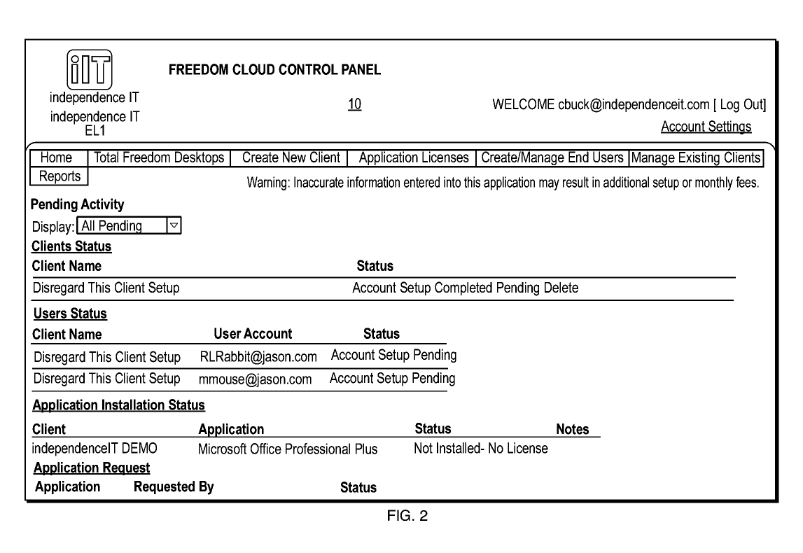

The Control Panel application 10 as shown in greater detail in FIG. 2, is the information technology manager's interface into the cloud workspace automated provisioning system 12 which implements the requested cloud workspace provisioning. The Control Panel 10 is a tool (preferably provided as a software application but can also be provided as a web page or series of web pages) that is developed for use by cloud service resellers, and which acts as a “wizard” by walking the reseller through the required questions and which facilitates the data entry of all of the information required by the cloud service provider to create a new client's cloud workspace. The Control Panel 10 allows a reseller to quickly and easily create a new client by entering in client/client company information; user information, application information; set up email services and in general all similar information required to initially set up a new client/customer; all without having detailed and/or skilled technical knowledge of all the underlying cloud services delivery platforms, programs and systems.

An operations console 11 allows the cloud services provider or reseller of cloud computing services the ability to perform common support and configuration tasks for users of the system. This operations console 11 allows trained but non-technical technicians to perform technical maintenance tasks that would otherwise require skilled and trained technical workers to execute. These tasks include (but are not limited to): manage existing users, add (create) new users to an existing account, manage application licenses, unlock user accounts, reset user passwords, force user to change their password on the next log in, set up a password that never expires, set up account expiration dates, create distribution and security groups, provide remote support, log off a user, explore and control processes running on a user's desktop perform remote installation, add or delete users, manage user application access, access and manage data storage areas, directly access and manage individual server instances for administrative tasks, configure security settings and access system logs of all activity for forensic and legal purposes, run, view and export system reports. Although the control panel 10 used for provisioning the cloud workspace and the operations console 11 utilized to manage the already existing cloud workspace are separate functionalities, they may be implemented in the same software web pages or application (tool).

Once the information technology specialist is done utilizing the Control Panel 10 to initially configure the user's environment or utilizes the operation console 11 to effectuate a specific user change, these changes are passed to the process automation system 12 (that is the “back end” process) which, is responsive to the information received from the control panel 10 and/or operations console 11 automates the process of creating organizational directory structures, data directory structures, users, cloud server systems, application installation, the initial setting of user privileges, and communication of all credentials and access details to the cloud services provider and user organization.

The process automation system 12 is preferably implemented as one or more software applications operating on appropriate computer server(s) and which receives as input the information output by the control panel 10 (in response to user input into the control panel), and information output by the operations console 11 (in response to user input into the operations console). The process automation system 12 utilizes the received information to automatically provision, manage and maintain the cloud services provided by the cloud service provider implementing the system and method of the present invention.

The method of the present invention involves a number of process steps, of which the following are a description:

A Customer is acquired by a Cloud Workspace™ services reseller.

The Reseller uses the control panel 10 to define one or more of the following service elements (or any similar service elements):

Selection of applications to be supported in the Cloud Workspace; Customer Organizational details; Listing of users to have access to the Cloud Workspace using Cloud Desktops; Selection of specific applications to which each individual user is to have access privileges; Submission of Application Licensing information or request for licensing to be provided by the Reseller or the cloud service provider; permission to copy or move files between the cloud desktop and local systems by accessing local system storage; permission to print files or documents from the cloud desktop to a user printer; permission to access system utilities; permission to use the operations console (11) for self support.

Next, the information submitted by the reseller via the control panel 10 is assembled into a storage database maintained and developed as part of the process automation system 12 following which the reseller information is processed from the storage database by the cloud service provider's Operations Console Platform 11 and fulfillment system.

Next, the process automation system 12 automatically and generally without further user input performs the following: the customer organization is defined within a system directory space using LDAP or other Organizational definition structure;

Policies regarding access to specific system resources are applied;

Specific server system resources to support the Cloud Workspace environment for the customer organization are automatically created using API calls to common virtualization management systems such as Microsoft Hyper-V, VMware, Citrix Xen, and Oracle's Virtual Box;

Individual user accounts are automatically created with access, application, data, and other system privileges automatically applied;

Cloud Workspace login information for each user is sent back to the reseller (via the control panel 10) for distribution to the customer organization;

Customer organizations access their Cloud Workspace using custom branded or co-branded user login application provided and developed by the service provider; and

The reseller manages common support requests using Operations Management tools provided and developed in accordance with the present invention including, but not limited to:

Reset Passwords; Unlock accounts; Provide direct remote support; Define data directory structures; Define data directory permissions for Individuals; Define Groups of individuals with common security attributes (Security Groups); and Assign data directory permission to Security Groups; Assign direct access to common support tools to designated administrative users within the Customer Organization

Accordingly, the present invention provides a system in method that automates most if not all of the administrative and maintenance tasks involved with provisioning and maintaining a cloud workspace for customers.

Modifications and substitutions by one of ordinary skill in the art are considered to be within the scope of the present invention, which is not to be limited except by the allowed claims and their legal equivalents.

The invention claimed is:

1. An automated system for automatically configuring and managing a complex information technology infrastructure, said system comprising:
an automated computer system operating under control of a computer program, and including:
a control panel mechanism, responsive to user input, and configured for allowing a user to establish a cloud services infrastructure including create a new information technology infrastructure client, create end users of the information technology infrastructure, select cloud applications and application licenses to be used by one or more users of the information technology infrastructure and for providing, as control panel output, cloud services infrastructure provisioning information formatted for use by an automated process automation system;
an operations console mechanism, responsive to user input, and configured for allowing previously established cloud services infrastructure support and configuration tasks for previously established users of the cloud services infrastructure system including manage existing information technology infrastructure clients, manage users, unlock user accounts, reset user passwords, force user to change their password on the next log in, set up a password that never expires, set up account expiration dates, create distribution and security groups, provide shadow support, log off a user, explore and control processes running on a user's desktop as well as remote installation, and for running reports related to the information technology infrastructure and its users and applications, and for providing, as operations console output, cloud services infrastructure and provisioning information formatted for use by said automated process automation system; and
an automated process automation system, coupled an responsive to said control panel mechanism output and said operations console mechanism output, for automatically, without human intervention and in response to said control panel mechanism output and said operations console mechanism output, controlling and implementing the process of creating and managing organizational directory structures, data directory structures, users, server systems, application installation, the initial setting of user privileges, and communication of all credentials and access details to the information technology services provider and user organization.
